(19) United States
(12) Patent Application Publication
(10) Pub. No.: US 2021/0065128 A1
(43) Pub. Date: Mar. 4, 2021

(54) SYSTEM AND METHOD FOR RECRUITMENT CANDIDATE EQUITY MODELING

(71) Applicant: Terminal 1 Limited, Kowloon (HK)

(72) Inventors: Edwin H. Shao, Sai Ying Pun (HK); Spencer Whitney Ying, Central (HK); Kin Chung Roger So, Quarry Bay (HK); Kirill Pavlov, Sheung Wan (HK)

(21) Appl. No.: 16/556,221

(22) Filed: Aug. 29, 2019

(51) Int. Cl. G06Q 10/10; G06Q 10/06; G06N 20/00

(52) U.S. Cl. CPC G06Q 10/1053; G06N 20/00; G06Q 10/067

(57) ABSTRACT

A computer-implemented method for modeling candidate equity includes tracking, in a computer system, a plurality of candidates in a recruiting pipeline including a plurality of stages, with each of the plurality of candidates being in a stage of the pipeline for a position and being owned by one of a plurality of recruiters. For each candidate, the system calculates a placement likelihood corresponding to the likelihood that the candidate will be placed in the position and computing a candidate equity based on the placement likelihood and an expected placement value. The system then compensates each recruiter based on revenue recognition rules and on an amount of change in the candidate equity of the candidates owned by the recruiter over time.

### FIELD

Provided herein are systems and method for a comprehensive system that allows a recruitment firm to award billings based on various pipeline activities that a recruiter can perform to improve the likelihood their candidate will become a placement.

### BACKGROUND

The recruitment firms commonly award commission based on billings determined using traditional accounting methods (e.g. upon offer acceptance, candidate join, invoice, or cash collection).

However, this way of measuring contribution (via accounting billings) fails to capture the entirety of value that recruitment consultants create in a given quarter. This traditional method is also prone to various tactics that may result in inaccurate measurements of recruitment effectiveness. Stacking, or artificially trying to move billings so they fall within one quarter, is just one example of potential tactics that may result in such inaccurate measurements of effectiveness.

Traditional recruitment techniques also fail to accurately capture much of the activity involved in successfully placing a candidate. A recruiter may spend a lot of time building their candidate pipeline by, for example, qualifying candidates, introducing candidates to clients, arranging interviews with clients, having offers out, or even secure accepted offers pending start date. However, none of these events will be recognized in a traditional billing system that only recognizes billings upon accounting events.

### SUMMARY

In an embodiment, a computer-implemented method for modeling candidate equity may include tracking, in a computer system, a plurality of candidates in a recruiting pipeline including a plurality of stages, each of the plurality of candidates being in a stage of the pipeline for a position and being owned by one of a plurality of recruiters. For each candidate, a placement likelihood may be calculated corresponding to the likelihood that the candidate will be placed in the position and computing a candidate equity based on the placement likelihood and an expected placement value. Each recruiter may then be compensated based on revenue recognition rules and on an amount of change in the candidate equity of the candidates owned by the recruiter over time.

In an embodiment, the candidate stages may include candidate registered, submitted, interview, offer, offer accepted, and invoice to client. The stages may further include pre-screening, second interview, third interview, fourth and subsequent interviews, and cash collection. The placement likelihood may be calculated from historical data and may be specific to a client, wherein the candidate position may be at the client. The placement likelihood for a stage may be a stage placement likelihood multiplied by a survival value. The stage placement likelihood may include a number of candidates who completed the pipeline divided by a number of candidates who entered the stage. The survival value models a likelihood that the candidate ever advances to a next stage and decreases over time, for example, to zero. The survival value may be modeled using an exponential or other statistical distribution.

In an embodiment, the placement likelihood may be computed by a machine learning model, where the machine learning model may accept as input a plurality of features. The machine learning model may be trained based on a dataset of training examples, each including the plurality of features and a placement label, with the placement label being an indication of whether a corresponding candidate was placed. The machine learning model may be an ensemble of decision trees or may be a neural network, among other implementations that are known or may become known. The plurality of features may include time in a stage, seniority of a candidate, resume text, job description, and expected salary of a position. The expected placement value may be an annual salary of the position multiplied by a client fee percentage. In an embodiment, a plurality of candidates may advance through various stages of a pipeline in response to user inputs of recruiters or one or more administrators.

In an embodiment, a computer-implemented method for modeling candidate equity may include tracking, in a computer system, a plurality of candidates in a recruiting pipeline including a plurality of stages, where each of the plurality of candidates may be in a stage of the pipeline for a position and corresponding to one of a plurality of recruiters. For each candidate, a candidate equity is computed corresponding to a value of the candidate based on the stage the candidate is in. Each recruiter is compensated based on invoiced amount or collected amount and a change in the candidate equity of the candidates owned by the recruiter over time.

### BRIEF DESCRIPTION OF THE DRAWINGS

The present disclosure will become more fully understood from the detailed description and the accompanying drawings, wherein:

FIG. 1A illustrates a computer system architecture for a recruitment candidate equity modeling system;

FIG. 1B illustrates a placement funnel for every candidate, in accordance with an embodiment;

FIG. 2 illustrates a graph of candidate equity over time in accordance with an embodiment;

FIG. 3 illustrates estimates for median, a, 2a, 3a deviations of transition time by stages in accordance with an embodiment;

FIG. 4 illustrates individual submission values displayed on an exemplary dashboard interface in accordance with an embodiment;

FIG. 5 illustrates an exemplary aggregated candidate value displayed for each recruiter on a daily basis, in accordance with an embodiment;

FIG. 6 illustrates an exemplary candidate equity pipeline value in a commission spreadsheet, in accordance with an embodiment;

FIG. 7 illustrates an exemplary analytics API definition, in accordance with an embodiment;

FIG. 8 illustrates an exemplary recruiter compensation process, in accordance with an embodiment;

FIG. 9 illustrates an exemplary recruiting stage pipeline, in accordance with an embodiment;

FIG. 10 illustrates an exemplary compensation process, in accordance with an embodiment; and

FIG. 11 illustrates a flow chart of a candidate equity modeling process, in accordance with an embodiment.

### DETAILED DESCRIPTION

In the following description, for purposes of explanation, specific details are set forth in order to provide an understanding of the subject matter disclosed herein. It will be apparent, however, to one skilled in the art that the invention can be practiced without these details. Furthermore, one skilled in the art will recognize that the embodiments described below may be implemented in a variety of ways, such as a process, an apparatus, a system, a device, or a method on a tangible computer-readable medium.

Components, or modules, shown in diagrams are illustrative embodiments. It shall also be understood that throughout this disclosure that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “an embodiment,” “some embodiments,” or “embodiments” means that a particular feature, structure, characteristic, or function described in connection with the embodiment is included in at least one embodiment and may be included more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. Furthermore, the use of memory, database, information base, data store, tables, hardware, and the like may be used herein to refer to system component or components into which information may be entered or otherwise recorded.

Furthermore, it shall be noted that unless otherwise noted: (1) steps may optionally be performed; (2) steps may not be limited to the specific order set forth herein; (3) steps may be performed in different orders; and (4) steps may be done concurrently.

A sophisticated placement analytical platform can be used to forecast the likelihood that any given candidate will be hired by a client and provide revenue to a recruiting firm. The placement analytical platform can be used to estimate the dollar value of the candidate's potential placement. The architecture of the placement analytical platform is made extensible in a variety of ways including the features used, the model used, back-testing and error measurement framework used.

The platform may primarily support two outcomes: revenue forecast and candidate-to-job match. For the revenue forecast, the placement analytical platform may use mean absolute percentage error (MAPE). For the candidate-to-job match, the placement analytical platform may predict a chance of the interview using a binary cross-entropy loss function.

The placement analytical platform includes features that can be used to determine the likelihood of a given candidate being hired by a client and producing value. For example, the placement analytical platform may consider the current stage of the candidate in the recruiting process, how long they've been in their current stage and whether they are stale, having been at the current stage for too long. The placement analytical platform may take into account which recruiter “owns” the candidate and which client or clients the candidate has been submitted to.

The placement analytical platform is architected to use and compare machine learning or statistical models in terms of their error rate. Example models include simple linear regression, elastic net, Neural Network, Boosting, LightGBM algorithm or any other suitable model.

The placement analytical platform includes a cross-validated back-testing framework. The placement analytical platform uses time series cross validation, where given pipeline of candidates and previous billing history, the model predicts revenue for the following quarter. In this way, the placement analytical platform minimizes mean absolute error of predictions. Other appropriate methods for back-testing and measuring error rate may be implemented.

An incremental billings and candidate equity commission system rewards recruiters for taking and recording actions that increase the likelihood, as determined by the placement analytics platform, that their candidates will become placements. The recruiters may use frontend tools to record relevant information and to visualize awarded billings, likelihood of placement, and actions the recruiters can take to increase the placement likelihood and billings.

A customer relationship manager allows the recruiters to store machine-readable information that the placement analytical platform requires, such as structured data of candidate attributes, candidate seniority, years of experience or contact information. The data may be stored in JSON format or other similar text-based or non-text storage formats. Data keys may include candidate name, phone, email, job availability, resume, expected salary, seniority, or other relevant data. The data may, for example, be stored in a NoSQL database. A customer relationship manager allows recruitment firms to store information about candidates, including, for example, resume, notes, job submission associations for candidates and other relevant data. A commission system accommodates the placement analytical platform, using an interest rate mechanism to encourage recruiters to put in data as early as possible. The placement analytical platform calculates incremental billings and commission payments. Incremental billing is internally calculated as the value of the invoice would be if the invoice was raised now. This is proportional to the probability of a candidate joining the company. Back-testing and error measuring frameworks may be implemented to measure how accuracy of candidate equity calculations and reduce awarded billings proportionate to projected error rate. The system may test logistic regression, elastic net, decision tree boosting, LightGBM and XGBoost algorithms, Tensorflow and neural networks or any other suitable testing or error metric. The commission system is not required to award stacking revenue in certain quarters and works well with spread out billings. Automated tests may be implemented to detect fraud and identify new heuristics.

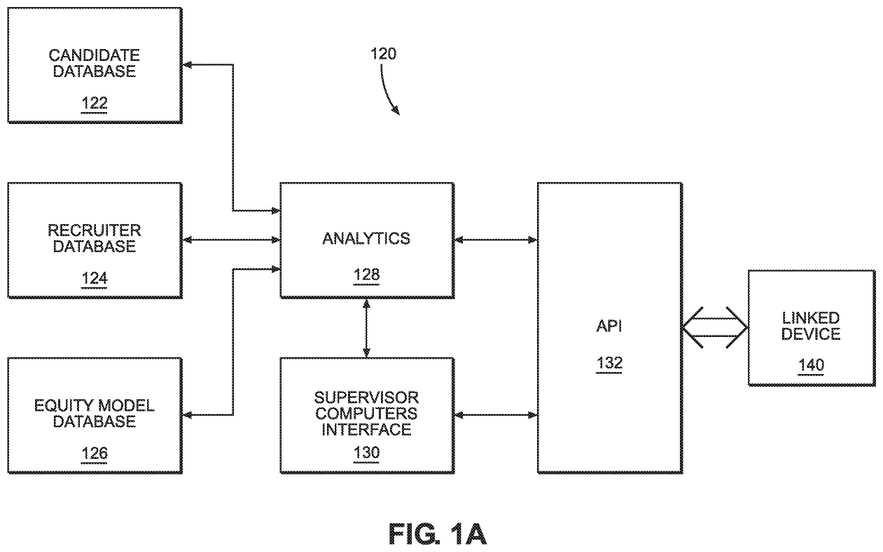

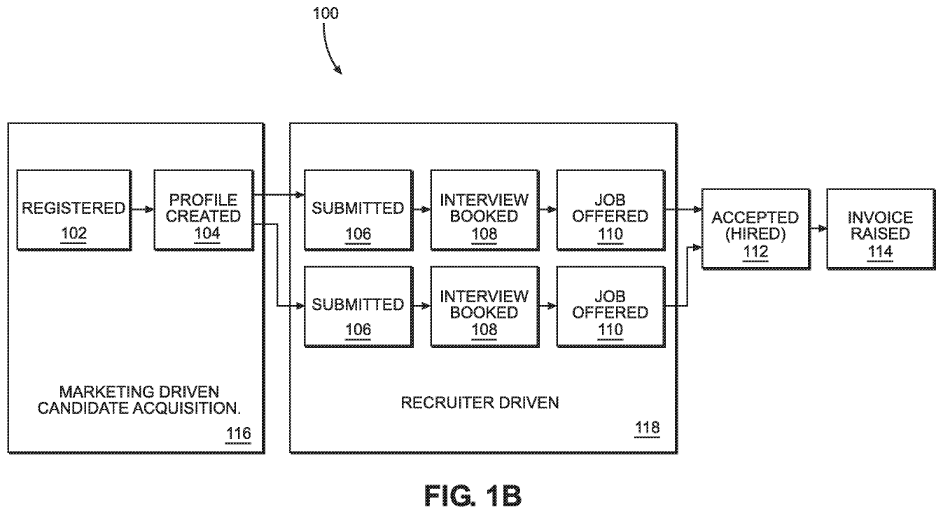

FIG. 1A illustrates a computer system architecture for a recruitment candidate equity modeling system 120, in accordance with an embodiment. A candidate database 122 stores profile information, historical information and other appropriate information regarding each candidate in the recruiting system. A recruiter database 124 stores information regarding each recruiter, including statistics and other relevant information. An equity model database 126 stores the equity states of each candidate and other relevant information regarding the predicted and potential value of a candidate. An analytics block 128 retrieves and provides information from the candidate database 122, the recruiter database 124 and the equity model database 126. The analytics block 128 communicates with an interface 130 that allows connection to supervisor computers. The interface 130 and the analytics block 128 communicate with an API 132. API 132 may communicate with one or more linked systems or devices 140, including but not limited to a remote computer, a local, wide or Internet network, either physically or otherwise communicatively coupled directly or indirectly.

FIG. 1B illustrates a placement funnel for every candidate 100 in accordance with an embodiment. In the first stage of the placement funnel, a candidate is registered in the registered stage 102. Next, a profile is created for the candidate in profile created stage 104. The profile may contain the candidates name, contact information, resume, credentials, experience level or any other data relevant to job placement. These first two stages 102 and 104 form a marketing driven candidate acquisition phase 116. The candidate and profile are used to create a client submission for the candidate in submitted stage 106. The candidate may be submitted to one or more clients for consideration. An interview between the client and the candidate is booked in interview booked stage 108. If the interview is successful, the candidate is offered a job in job offered stage 110. These three stages 106, 108 and 110, form a recruiter driven phase 118. The candidate accepts a job offer and is hired by a client in accepted (Hired) stage 112. An invoice is raised in the invoice raised stage 114.

The first two stages of the placement funnel, registration 102 and profile creation 104 are marketing driven candidate acquisition stages. The next three stages of the placement funnel, submitting the candidate to a client 106, booking an interview 108 and job offers 110 are recruiter-driven stages. Not all candidates are submitted to all clients, but rather only selected candidates are submitted to selected clients. Every candidate may be submitted to multiple clients.

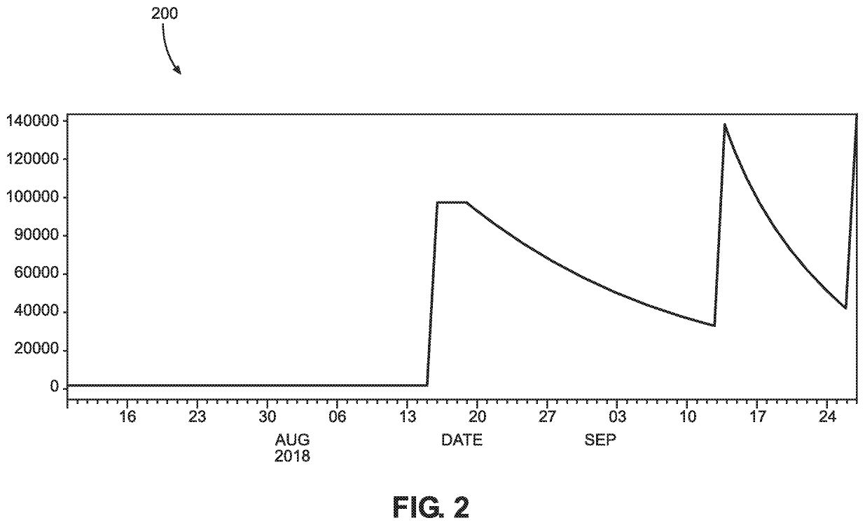

FIG. 2 illustrates a graph of candidate equity over time 200 in accordance with an embodiment. The graph shows the candidate equity vs. time for a single candidate. Each spike corresponds to a candidate stage transition. Every time the recruiter transitions the candidate to the next stage, the candidate equity grows. Then the candidate equity depreciates with time. The model determines placement probability for every submission given candidate's stage, time spent in that stage and client this candidate is submitted to. Using historical data, transition and placement probabilities overall are calculated for clients with more than 30 submissions. Clients with less than 30 submissions use aggregated estimates to define the transition and placement probabilities. These probabilities are assigned to submissions when candidates transition to a new stage and decrease with time according to survival model. Based on historical data, the model calculates transition probabilities. These probabilities are then used as input to refine transition probability for every candidate. The longer the candidate stays in the stage, the lower the probability. By using this approach, even if a recruiter forgets to change candidate's stage, the candidate's submission value would eventually decrease to zero. In general, if a candidate stays in the same stage for more than 90 days, the candidate's submission value is set to zero because within this time period every submission should result either in placement or rejection. Submission value may be calculated as the expected placement fee (candidate expected salary times the client's rate) times the probability of placement givens that candidate is in submission stage now. The value of a candidate increases on funnel stage transition and decreases with time or after rejection. The depreciation schedule depends on the stage and is determined using survival analysis: exponential estimation of likelihood of advancing to the next stage after a given number of days. Every day, the probability that a candidate will transition to the next stage decreases by a given percentage, where the percentage is determined using historical data. The depreciation schedule refers to the percentage of value remaining after a given number of days.

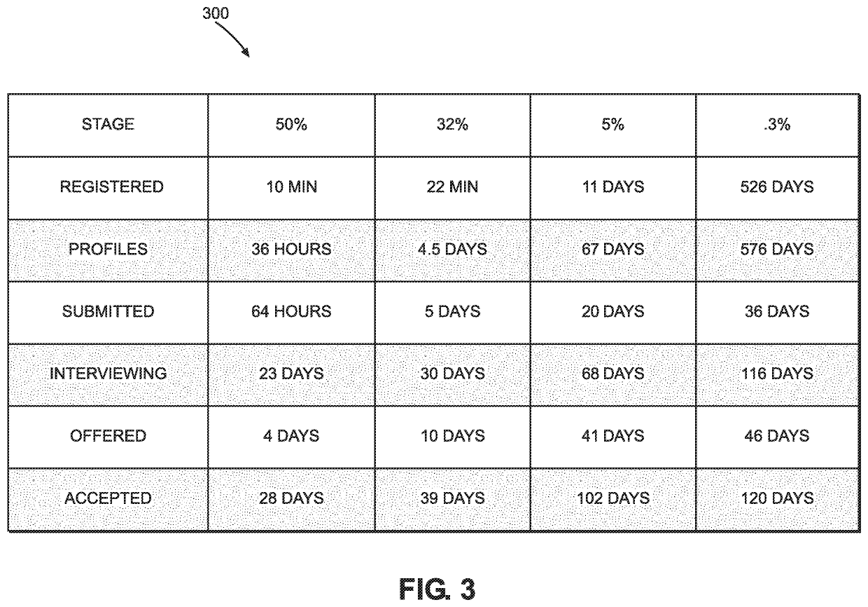

FIG. 3 illustrates estimates for median, a, 2a, 3a deviations of transition time by stages 300 in accordance with an embodiment. While on average it takes 36 hours to submit a candidate after registration, it takes 23 days between the interview and offer or rejection decision. This shows exemplary aggregated data for a set of candidates and used for illustration purpose. The model may embed this information into the depreciation schedule.

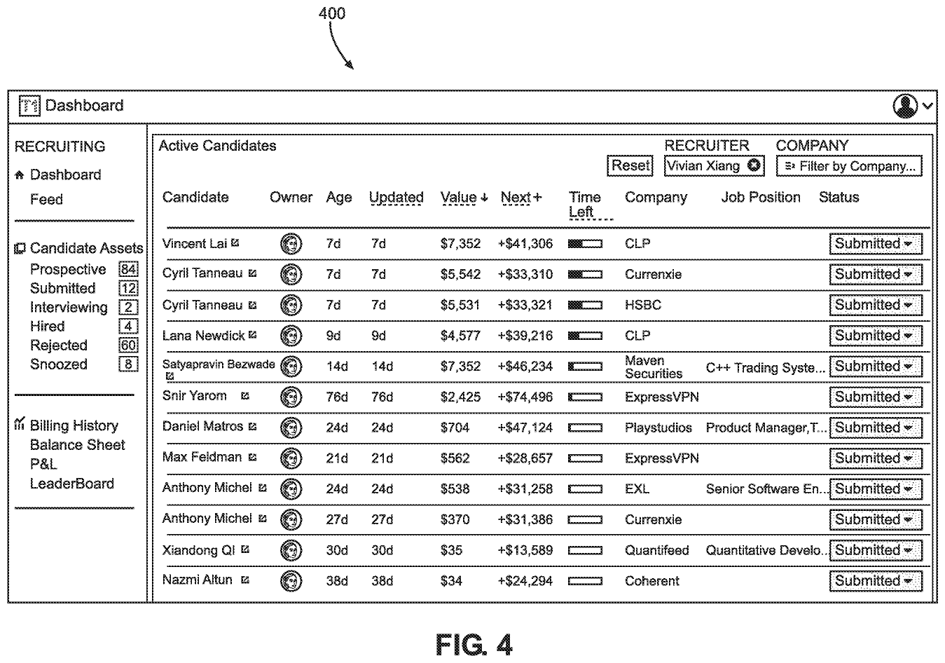

FIG. 4 illustrates individual submission values are displayed on our dashboard interface 400 in accordance with an embodiment. The dashboard interface 400 may be, but is not limited to, a web interface. In addition to the current value, time in stage and likelihood of a rejection in “Time Left” column are displayed.

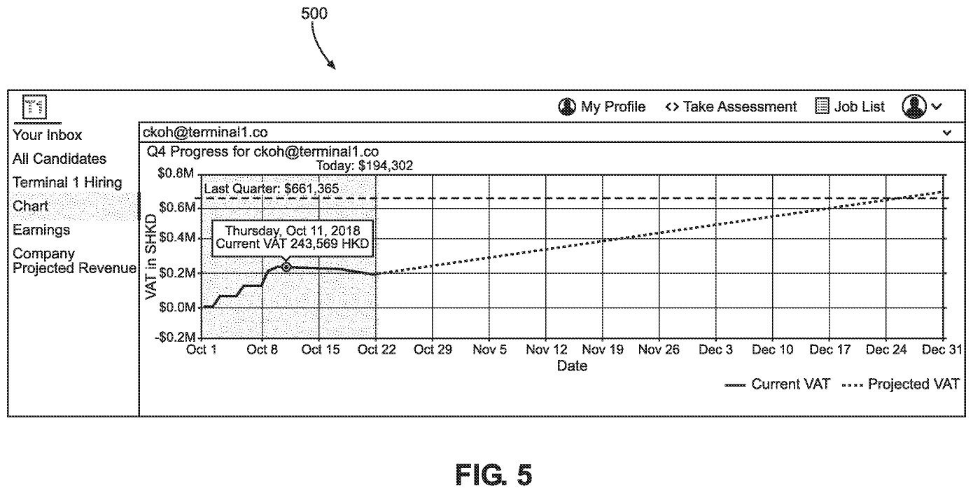

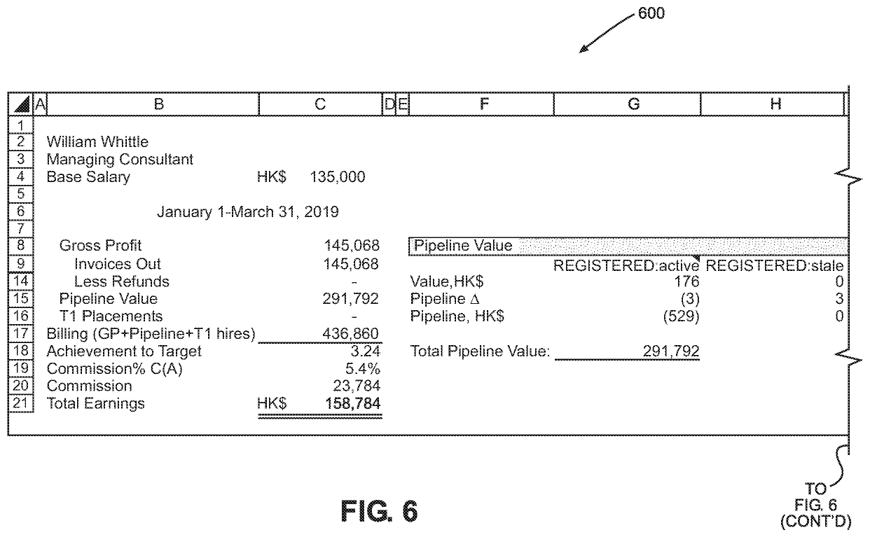

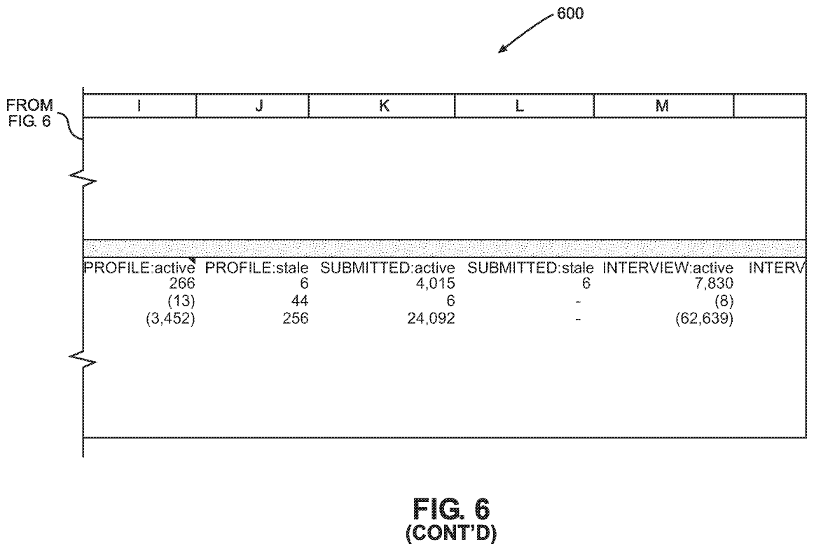

FIG. 5 illustrates a display for aggregated candidate value for each recruiter on a daily basis 500, in accordance with an embodiment. This allows recruiters to track their performance and compare it quarterly target. Every quarter, when commissions are paid to the recruiters, a pipeline value is calculated for every recruiter. In the report the candidates are grouped together with the other candidates at the same stage. The first line in Pipeline Value table on FIG. 6 shows the average value of a candidate in that stage, for example, the value of active registered candidate is 176 HK$. The second line shows difference in the pipeline from the previous quarter. For example, if in the previous quarter, a recruiter had 10 candidates in the submitted stage and in the current quarter there are only 7 submitted, the recruiter generated −3 candidates (values in brackets are negative), hence the value of the pipeline is −3*176=−529 HKD$. Total pipeline value is the sum of pipeline values for each stage.

If, by way of example, in the first quarter, a candidate was submitted, and the pipeline would reflect 1 submission candidate values at 4015. The total value of the pipeline would be equal to 1 times 4015, equaling 4015. Next quarter this candidate moves to interview stage, so pipeline difference would be +1 interview and −1 submission. In this case, the total value of the recruiter's pipeline would be −1 times 4014 plus 1 times 7830, equaling 3815.

FIG. 6 illustrates a candidate equity pipeline value in a commission spreadsheet 600, in accordance with an embodiment.

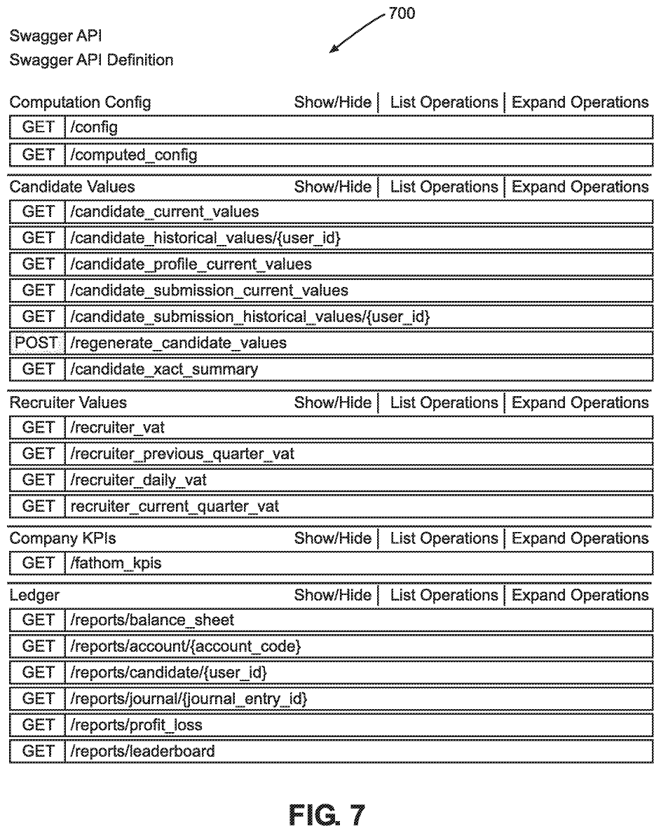

FIG. 7 illustrates analytics API definition 700, in accordance with an embodiment.

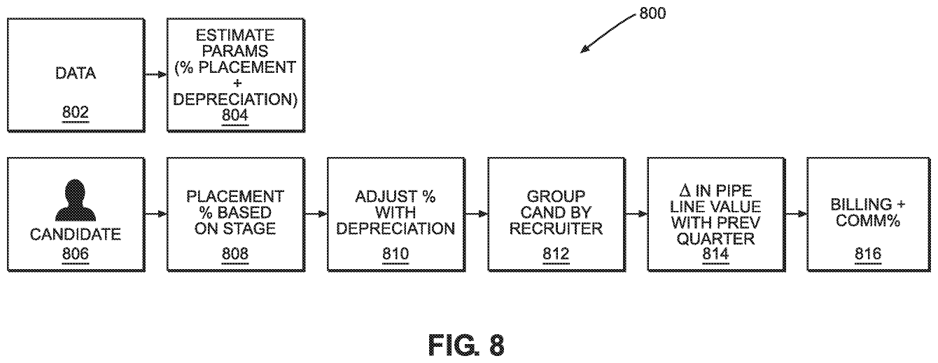

FIG. 8 illustrates a recruiter compensation process 800 in accordance with an embodiment. Historical data 802 is used to estimate parameters 804 that will be used in the compensation calculation process. For each candidate 806, a placement percentage 808 is determined, based on the recruitment stage reached by the candidate. The placement percentage 808 is then adjusted by a depreciation amount determined by the length of time since the last change in the candidate's state, defined as the “staleness” of the state. For each recruiter, the candidates belonging to the recruiter are grouped 812. The change in the pipeline value at the end of the present quarter, relative to the previous quarter, is calculated in step 814. The billing and commission percentage 816 is used to determine the recruiter's compensation.

Pipeline activities include moving candidate to the next stage of the recruitment funnel, e.g. submitting candidates, booking an interview, negotiating the offer with client, negotiating the offer with candidate, making sure candidate shows up after offer acceptance. Attribute of candidates include features generated based on his/her resume (e.g. technologies mentioned, years of experience) and results of our in-house assessment (engineer conducts a call or candidate implements take-home coding challenge).

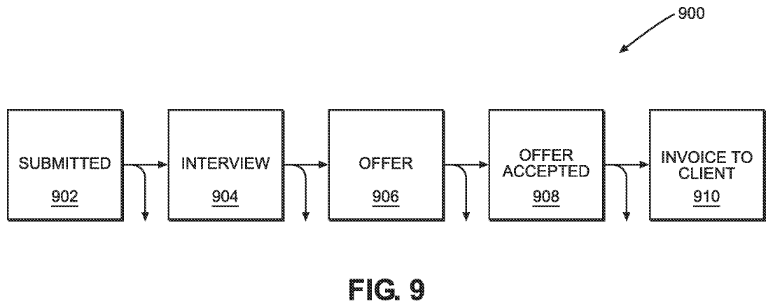

FIG. 9 illustrates a recruiting stage pipeline 900, in accordance with an embodiment. A candidate is submitted in step 902. The candidate may drop out at that stage or proceed to the interview stage 904. The candidate may drop out after that stage or proceed to the offer stage 906. The candidate may refuse the offer and drop out or proceed to the offer accepted stage 908. An invoice is sent to the client in step 910. The transition percentage is calculated as the ratio between the number in one stage and the number in the next stage. The placement percentage is calculated as the ratio between the number of candidates that were submitted and the number of candidates that were invoiced.

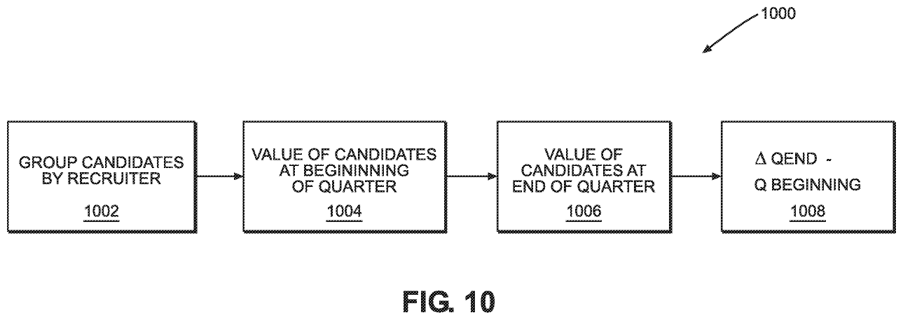

FIG. 10 illustrates a compensation process 1000, in accordance with an embodiment. The candidates are grouped according to the recruiter handling their recruitment 1002. The total value of the recruiter's candidates is calculated 1004 corresponding to their total value the beginning of the quarter. The total value of the recruiter's candidates is calculated 1006 corresponding to their total value at the end of the quarter. The difference between the total value at the beginning of the quarter and the total value at the end of the quarter is calculated 1008.

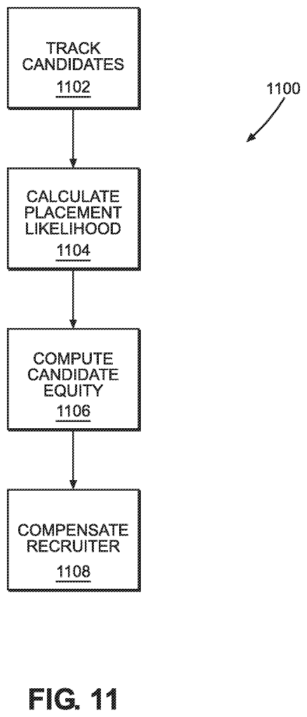

FIG. 11 illustrates a flow chart of a recruitment candidate equity modeling process 1100, in accordance with an embodiment. The candidates in a recruiting pipeline are tracked in step 1102. The recruiting pipeline includes a sequence of stages leading toward the candidate receiving a position at a client. The candidates progress through the stages is tracked. Each candidate is owned by a recruiter. For each candidate, the system calculates a placement likelihood corresponding to the likelihood that the candidate will be placed in the position in step 1104. The system computes candidate equity based on the placement likelihood and an expected placement value in step 1106. The system then compensates each recruiter in step 1108 based on revenue recognition rules and on an amount of change in the candidate equity of the candidates owned by the recruiter over time.

The model fundamentally predicts the probability of placement of a given candidate to a given job. The output of the model is a number between 0 and 1. In order to assign the value to every submission, placement probability is multiplied by placement value, how much fee may be collected upon successful placement.

This model may be used in multiple placements. A recruiter dashboard and commission calculation may be made using the value of the pipeline which is calculated based on the placement probability. This calculation affects the total billing of a recruiter. A candidate discovery interface may allow recruiters to search for candidates who match the job requisition they are working on. Candidates that have a higher placement probability would be on top of the result list. A candidate facing interface may present top client suggestions.

When predicting placement probability, a wide variety of features may be used including relevancy of candidate's resume to job description, authorized locations to work, visa requirements, MBTI type, company size and recruiter who submits the candidate. Recruiters will therefore see different placement probabilities for the same candidate based on the recruiters features and history. The model takes into account features from all parties involved, the client, the candidate and the recruiter. This happens because recruiters behave differently, for example, some write very detailed cover mails, some would just submit many candidates and see who works out. Because of this, the model is customized to account for individual recruiters.

In order to improve the quality of the prediction, the machine learning model aggregates the output of decision tree algorithms (boosting of decision trees) and neural network (3 layers network with dropout architecture).

Recruiters are rewarded for “Candidate Equity” generation as we include it as a component of a total billing. Final commission payout equals to Billings times Commission Rate and is calculated on a quarterly basis. The value of a candidate is equal to the probability of being placed times the expected placement value, for example, the annual salary the candidate would be expected to receive and the client fee.

The probability of placement could be estimated using machine learning. The model would be trained with features such as stage, time in stage, seniority, expected salary and other relevant features. The model could be trained using labels, such as whether the candidate has been placed or not.

Billing equals Gross Profit plus Candidate Pipeline Adjustments (“Candidate Equity” described above), where Gross Profit is defined using accounting principles and Candidate Pipeline Adjustments are defined by the system based on historical data analysis. Every candidate is assigned either GP or Pipeline value and could not have both at the same time. When an invoice for a candidate is raised, their pipeline value converts to GP.

Commission Rate depends on quarterly base salary and billing and is may be defined, for example, by the following formula:

$$C ( A ) = 22.7 \% \times \{ \begin{matrix}0.044 \times A & if A < 3 \\ min ( 2.7 , ln ( A - .92 ) - 0.6 ) & if A \geq 3\end{matrix}$$

Where A is an achievement to target=billing divided by base salary.

In accordance with an embodiment, the commission grows linearly until A=3 and then grows as logarithm up to about a maximum value. This commission scheme rewards any positive contribution and monotonically increases, so higher billing yields higher fee percentage. It also adheres to the following principles: the more risk recruiter takes (the lower the base salary), the higher the reward (total compensation: base salary+commission); commission percentage increases up to a maximum value; and the linear component allows managing company risk when recruiters underperforming A<2.

The placement analytical platform is able to estimate the likelihood a candidate will become a placement is constantly improving. The recruiters have much more of an incentive to put in correct, timely, and comprehensive data because they're rewarded for doing so. There is much more of an incentive for everyone to double-check the accuracy of data because it is tied directly into actual monetary commission payments. The modularity of the placement analytical platform improves reporting. For example, the placement analytical platform may determine which clients are better, for example, more likely to interview candidates), but also whether combinations matter, for example, if only a certain recruiter submitting to a given client that results in poor likelihood of placement.

Based on historical data the placement analytical platform calculates model parameters and then uses these parameters to calculate candidate values. Based on individual candidate values, the placement analytical platform forecasts company revenue and calculate recruiters commission.

Historical data may be used to calculate transition probabilities and probabilities of placement. For example, the transition from submission to interview percentage would be calculated by dividing the number of interviews by the number of submissions.

This same data may be used to calculate depreciation curves. A depreciation curve represents ratio of candidates transitioned to the next stage after “x” days, as a function of time. At time 0 it's always 100% and goes to 0% with time. If, for example, 50% of candidates transitioned to the next stage within 10 days, then depreciation (10 days)=1−50%=50%. This dependency allows the placement analytical platform to manage stale candidates in case their status was not updated.

For every candidate, the placement analytical platform calculates value as a product of placement probability and expected fee. A Bayesian model may be used to calculate placement probability. Machine learning could be implemented to perform this calculation.

When value for each candidate is defined, we could forecast company revenue and recruiter commission. Commission may be calculated for example, as: recruiters take home base salary+commission, which depends on billing. Billing is defined as Gross Profit (Invoiced amount) plus Pipeline adjustments.

Pipeline adjustments is calculated as the change in candidate equity between the end and the beginning of the quarter. In example below, a recruiter owned 20 candidates in submitted stage, 3 interviewing and 1 candidate with the offer. At the end of the quarter the same recruiter owned 15 candidates in submitted stage, 5 interviewing and 1 who accepted the offer, not necessarily the same candidates as at the beginning of the quarter. The difference is calculated in terms of candidates and the total value is then calculated. This value could be negative in a particular quarter. Change in the candidate equity represents work done by recruiter prior to candidate placement and client invoicing. It helps to bring some of the revenue forward and reward recruiters earlier.

Award billing is the base number that is multiplied by a rate to calculate commission earned. At most firms, it may be invoices out or cash collected

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

1. A computer-implemented method for modeling candidate equity comprising:
registering a plurality of candidates in a candidate database;
generating a profile for each candidate and storing the profiles in the candidate database;
submitting a candidate to one or more job positions, based on the candidate profile, wherein the one or more job positions are associated with one or more clients;
assigning a recruitment stage parameter to each submitted candidate, based on state of the candidate in a recruiting pipeline, wherein the recruiting pipeline comprises a plurality of recruitment stages;
for each recruitment stage, computing a transition percentage as the ratio between the number of candidates reaching the next stage and the number of candidates reaching the current stage;
storing the assigned recruitment stage parameter in an equity model database;
storing in the equity model database an identifier of a recruiter associated with the candidate, obtained from a recruiter database;
tracking, in the equity model database, a plurality of candidates in the recruiting pipeline, wherein tracking comprises updating the assigned recruitment stage parameter for each submitted candidate in the equity model database, based on state of the candidate in the recruiting pipeline;
for each candidate, generating in an analytics module comprising a machine learning model, a transition likelihood, comprising a likelihood of the candidate transitioning between stages of the recruiting pipeline, wherein the transition likelihood is generated, at least in part, based on the transition percentage and an amount of time the candidate has spent in a stage of the pipeline, wherein the transition likelihood decreases exponentially by a given percentage each day, the percentage calculated from historical data including the median and standard deviation of past transition times;
for each candidate, generating by the machine learning model, a placement likelihood corresponding to likelihood that the candidate will be placed in the position based on inputting to the machine learning model a plurality of features including a current stage of the candidate in the recruiting pipeline, wherein the machine learning model is trained based on a dataset of training examples each comprising the plurality of features and a placement label, the placement label comprising an indication of whether a corresponding candidate was placed;
for each candidate, adjusting the placement likelihood by a depreciation amount comprising a staleness parameter, the staleness parameter determined by the length of time since the last change in the candidate's stage;
generating, in the analytics module, a candidate equity based on the placement likelihood and an expected placement value associated with the client; and
calculating the difference between the candidate equity at a first time and the candidate equity at a second time.

2. The computer-implemented method of claim 1, wherein the stages include candidate registered, submitted, interview, offer, offer accepted, and invoice to client.

3. The computer-implemented method of claim 2, wherein the stages further include pre-screening, second interview, third interview, and cash collection.

4. The computer-implemented method of claim 1, wherein the placement likelihood is calculated from historical data.

5. The computer-implemented method of claim 4, wherein the historical data is specific to a client, wherein the position is associated with the client.

6. The computer-implemented method of claim 4, wherein the placement likelihood for a stage comprises a stage placement likelihood multiplied by a survival value.

7. The computer-implemented method of claim 6, wherein the stage placement likelihood comprises a number of candidates who completed the pipeline divided by a number of candidates who entered the stage.

8. The computer-implemented method of claim 7, wherein the survival value models a likelihood that the candidate ever advances to a next stage.

9. The computer-implemented method of claim 8, wherein the survival value decreases over time to 0.

10. The computer-implemented method of claim 9, wherein the survival value is modeled with an exponential distribution.

11. The computer-implemented method of claim 1, wherein the machine learning model aggregates outputs of decision trees and a neural network.

12. The computer-implemented method of claim 1, wherein the machine learning model is an ensemble of decision trees.

13. The computer-implemented method of claim 1, wherein the machine learning model comprises a neural network.

14. The method of claim 11, further comprising inputting to the machine learning model a further plurality of features including time in the stage, seniority of the candidate, resume text, and expected salary of the position.

15. The computer-implemented method of claim 1, wherein the expected placement value comprises an annual salary of the position multiplied by a client fee percentage.

16. The computer-implemented method of claim 1, further comprising advancing a plurality of candidates through the stages of the pipeline in response to user inputs of the recruiters or one or more administrators.

17. Non-transitory computer storage that stores executable program instructions that, when executed by one or more computing devices, configure the one or more computing devices to perform operations comprising:
registering a plurality of candidates in a candidate database;
generating a profile for each candidate and storing the profiles in the candidate database;
submitting a candidate to one or more job positions, based on the candidate profile, wherein the one or more job positions are associated with one or more clients;
assigning a recruitment stage parameter to each submitted candidate, based on state of the candidate in a recruiting pipeline, wherein the recruiting pipeline comprises a plurality of recruitment stages;
for each recruitment stage, computing a transition percentage as the ratio between the number of candidates reaching the next stage and the number of candidates reaching the current stage;
storing the assigned recruitment stage parameter in an equity model database;
storing in the equity model database an identifier of a recruiter associated with the candidate, obtained from a recruiter database;
tracking, in the equity model database, a plurality of candidates in the recruiting pipeline, wherein tracking comprises updating the assigned recruitment stage parameter for each submitted candidate in the equity model database, based on state of the candidate in the recruiting pipeline;
for each candidate, generating in an analytics module comprising a machine learning model, a transition likelihood, comprising a likelihood of the candidate transitioning between stages of the recruiting pipeline, wherein the transition likelihood is generated, at least in part, based on the transition percentage and an amount of time the candidate has spent in a stage of the pipeline, wherein the transition likelihood decreases exponentially by a given percentage each day, the percentage calculated from historical data including the median and standard deviation of past transition times;
for each candidate, generating by the machine learning model, a placement likelihood corresponding to likelihood that the candidate will be placed in the position based on inputting to the machine learning model a plurality of features including a current stage of the candidate in the recruiting pipeline, wherein the machine learning model is trained based on a dataset of training examples each comprising the plurality of features and a placement label, the placement label comprising an indication of whether a corresponding candidate was placed;
for each candidate, adjusting the placement likelihood by a depreciation amount comprising a staleness parameter, the staleness parameter determined by the length of time since the last change in the candidate's stage;
for each candidate, generating in the analytics module, a candidate equity based on the placement likelihood and an expected placement value associated with the client; and
calculating the difference between the candidate equity at a first time and the candidate equity at a second time.

18. The computer storage of claim 17, wherein the machine learning model aggregates outputs of decision trees and a neural network.

19. The computer storage of claim 17, wherein the machine learning model is an ensemble of decision trees, and/or a neural network.

20. The computer storage of claim 19, wherein the machine learning model comprises a neural network, wherein the plurality of features includes time in the stage, seniority of the candidate, resume text, and expected salary of the position.
